(19) United States
(12) Patent Application Publication
(10) Pub. No.: US 2006/0185947 A1
(43) Pub. Date: Aug. 24, 2006

(54) Gas spring

(75) Inventor: Rolf Mintgen, Thuer (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/344,399

(22) Filed: Jan. 31, 2006

(30) Foreign Application Priority Data
Feb. 4, 2005 (DE) 102005004 982.6-1

(51) Int. Cl. F16F 9/52

(52) U.S. Cl. 188/277

(57) ABSTRACT

A gas spring includes a pressure tube having a first pressure chamber and a second pressure chamber, the pressure tube being filled with a pressure fluid. An actuating device that can move relative to the pressure tube is acted on by the pressure fluid. A flow channel connects the first pressure chamber to the second pressure chamber, and a heater is arranged within the flow channel and/or immediately adjacent to the flow channel.

### BACKGROUND OF THE INVENTION

1. Field of the Invention

The invention concerns a gas spring with a pressure tube that has a first pressure tube chamber and a second pressure tube chamber and is filled with a pressure fluid, with a pressure fluid flow channel that connects the first pressure tube chamber and the second pressure tube chamber, and with a heater for heating the pressure fluid, wherein the pressure fluid can act on an actuating device that moves relative to the pressure tube.

2. Description of the Related Art

A previously known gas spring of this type is designed as a lifting aid for opening and holding open tailgates and trunk lids of motor vehicles. This gas spring has a metallic cylinder that is closed at one end, a damping piston supported therein, a metallic piston rod connected to the damping piston, and a seal at the open end of the cylinder between the cylinder and the piston rod. In general, the extension force of gas springs is temperature-dependent, since the pressure of an enclosed gas volume varies as a function of temperature. For this reason, an electric heater is installed in the cylinder of the aforementioned gas spring and is directly assigned to the enclosed gas volume. This heater is intended to make it possible to achieve damping characteristics of the gas spring that are largely independent of fluctuations in ambient temperature.

For use as a moving aid for movable structural parts in structures that are exposed to varying ambient temperatures, another well-known gas spring that has a compressed gas volume is provided with an electric heater. To compensate pressure variations of the compressed gas volume caused by variations of the ambient temperature of the gas spring, the electric heater is assigned to the gas spring in a way that allows heat exchange with the compressed gas volume.

In the gas springs described above, the heater acts on a compressed gas volume that is at rest, and this results in an inhomogeneous heat distribution in the compressed gas volume and a high heating capacity requirement.

Furthermore, spring strut units are known, in which, in addition to gas springs, steel springs with spring characteristics that are essentially independent of the ambient temperature take over a considerable part of the extension force. Spring strut units of this type are heavy, are relatively expensive, and, in addition, produce unwanted noise.

### SUMMARY OF THE INVENTION

Proceeding on the basis of the prior art, the objective of the present invention is to create a gas spring of the aforementioned type which has spring characteristics that are largely independent of temperature and in which a low heating capacity is required.

In accordance with the invention, this objective is achieved in a gas spring of the aforementioned type by arranging the heater within the flow channel and/or immediately adjacent to the flow channel.

In a gas spring of the invention, this results in the special advantage that the pressure fluid, which is preferably a gas, such as, say, compressed nitrogen, is in direct contact with the heater as it flows. The heater is located directly in or immediately adjacent to a flow path of the pressure fluid. Compared to heaters known from the prior art, which heat a stationary gas volume, the invention provides significantly improved heat transfer from the heater to the pressure fluid, so that it becomes possible both to achieve faster heating of the pressure fluid and to reduce the required heating capacity. The efficiency of the heater is significantly enhanced. Due to heating of the pressure fluid as it flows through the flow channel, especially at low ambient temperatures, a pressure drop in the gas spring due to a temperature reduction can be compensated. Consequently, the gas spring of the invention is especially well suited for use within a wide temperature range, for example, in motor vehicles. The heater is preferably an electric heater, especially an electric resistance heater, which can be electrically connected, for example, by contact strips on the pressure tube and sliding contacts; it

[symbol]

In this regard, it is especially advantageous with respect to compact construction and operating reliability of the gas spring if, in accordance with another refinement of the invention, the flow channel is located in the piston. For example, the flow channel can be formed as an axial peripheral groove, or it can pass through the piston axially in the form of a tube. As the pressure fluid flows through the piston, it becomes heated, and this effect can be used to compensate a pressure drop in the gas spring due to a temperature reduction.

In accordance with another advantageous refinement of the invention, the piston and the heater are connected with each other to form a single component. For example, the heater can be arranged in a simple way on the surface of the piston at the outlet of the flow channel, so that the pressure fluid can flow through it.

The design and the manufacture of the gas spring can be further simplified if the piston has a piston ring that is installed radially between the piston and an inner wall of the pressure tube, and if an outer surface of the piston that faces the piston ring and an inner surface of the piston ring that faces the piston form at least a section of the flow channel.

In accordance with another advantageous refinement of the invention, the heater is installed in the piston ring, so that a further increase in the level of component integration of the gas spring can be achieved.

In accordance with another refinement of the invention, it is especially advantageous if the piston ring can be moved axially relative to the piston. In this way, the piston ring can simultaneously act as a check valve that prevents pressure fluid from flowing back through the flow channel when the piston ring is in an axially displaced position and blocks the flow channel.

A well-defined valve function with an exact closed position can be realized without compromising a long service life and a high degree of operating reliability if the piston has a first axial stop and a second axial stop, which is spaced a certain axial distance from the first axial stop, to limit the axial movement of the piston ring, and if the piston ring is installed between the two axial stops.

To provide the gas spring with an especially simple design, it is advantageous if at least part of the heater forms a wall of the flow channel. In this case, the pressure fluid that flows through the flow channel is in direct contact with the heater.

In accordance with another advantageous refinement of the invention, the piston has two axially spaced piston rings, and the heater is installed between the two piston rings in the flow channel, so that the pressure fluid can flow through and/or around the heater. Among other things, an embodiment of this type allows dynamic end-of-travel damping of the piston.

A return stroke of the actuating device can be realized in a very simple way by providing a second flow channel that connects the first pressure tube chamber and the second pressure tube chamber, where the pressure fluid can flow through the two flow channels in opposite directions.

In this regard, an especially high degree of operating reliability of the gas spring is achieved if each of the flow channels has a check valve, and if the check valves are arranged in opposite directions. can be advantageous to design the heater as an electrically heated heat exchanger. In the gas spring of the invention, it is especially advantageous if the heater basically needs to be operated only on a temporary basis, namely, when pressure fluid is flowing through the flow channel and/or possibly only when the ambient temperature of the gas spring falls below a temperature threshold value, which, for example, can be preset. Permanent heating is not necessary. A possibly desired locking of the actuating device, which, for example, can have a piston rod that can be connected to a motor vehicle tailgate for supporting operation of the vehicle tailgate, can be accomplished, for example, by means of a check valve in the flow channel. Due to the assignment of the heater to the flow channel and the relatively low heating capacity requirement, the gas spring of the invention can have the advantageous features of a very compact construction and a low weight. The pressure tube is preferably a cylinder.

The design of the gas spring is simplified, and especially good heat transfer to the pressure fluid is realized, if the pressure fluid can flow through and/or around the heater, which is installed at an outlet of the flow channel or at an inlet of the flow channel.

In accordance with another refinement of the invention, it is advantageous, especially in regard to a high degree of operating reliability and a long service life, if the actuating device has a piston which separates the first pressure tube chamber from the second pressure tube chamber and which can be bypassed by the pressure fluid through the flow channel.

In accordance with a refinement of the invention, the check valve of the second flow channel is a check valve with temperature-dependent closing force. A temperature-controlled check valve of this type, which, for example, can have a bimetal spring, can reliably ensure that the second flow channel, which allows return flow of the pressure fluid, is closed at low temperatures. If the actuating device, especially a piston with a piston rod, is pushed into the pressure tube, the temperature-controlled valve offers a certain amount of opening pressure, which is higher at relatively low temperatures than at relatively high temperatures. The gas spring thus remains reliably extended even at low temperatures. Another advantage of the temperature-controlled valve is that heating of the pressure fluid and thus operation of the heater are necessary only when the actuating device, especially a piston rod, is extended; in the extended position of the actuating device, the element to be operated with the gas spring, for example, a motor vehicle tailgate, is held by the opening pressure.

In accordance with another advantageous refinement of the invention, in a middle section of the maximum travel of the actuating device, the inner wall of the pressure tube has a bypass groove, through which the pressure fluid can flow to bypass the actuating device. This groove, which serves as a bypass line, allows faster movement of the actuating device in its middle travel range, whereas the movement of the actuating device is slowed before the end-of-travel positions of the actuating device are reached due to increased opposing forces. In the case of a cylinder with a piston that has a piston rod, the groove thus extends over a certain middle section of the stroke of the piston but not into the end-of-travel regions of the stroke.

Specific embodiments of the invention are illustrated schematically in the drawings and are explained in greater detail below.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a gas spring in a longitudinal section;

FIG. 2 shows a detail section of a pressure tube of a different gas spring with a heater;

FIG. 3 shows a detail section of a pressure tube of a third gas spring with a heater; and

FIG. 4 shows a detail section of a pressure tube of a fourth gas spring with a heater.

Corresponding parts are labeled with the same reference numbers in all of the drawings.

### DETAILED DESCRIPTION OF THE PRESENTLY PREFERRED EMBODIMENTS

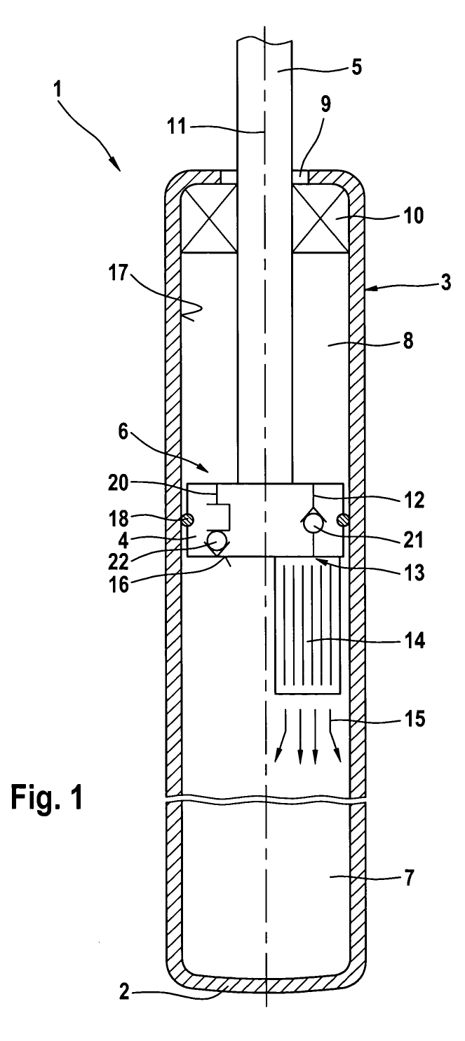

FIG. 1 shows a longitudinal section of a gas spring 1 with a pressure tube 3, which is closed at one end and has a base 2. The pressure tube 3 is filled with a gas that serves as the pressure fluid. A piston 4 with a one-sided piston rod 5 is guided in the pressure tube 3. This piston 4 serves as an actuating device 6, which can be moved relative to the pressure tube 3, namely, in the direction of the center axis 11 of the pressure tube 3, and which operates a motor vehicle tailgate (not shown) that is operatively connected with the piston rod 5. At the opposite end of the pressure tube 3 from the base 2, the pressure tube 3 has an opening 9, through which the piston rod 5 extends out of the pressure tube 3. A seal 10 seals the opening 9 from the piston rod 5.

The pressure tube 3 has a first pressure tube chamber 7 and a second pressure tube chamber 8, which are separated from each other by the piston 4. The two pressure tube chambers 7, 8 are connected by a flow channel 12 located in the piston 4. A heater 14, through which the pressure fluid can flow and which heats the pressure fluid, is installed directly at an outlet 13 of the flow channel 12 into the first pressure tube chamber 7 and thus immediately adjacent to the flow channel 12. The pressure fluid, which flows through the heater 14 when it flows over from the second pressure tube chamber 8 into the first pressure fluid chamber 7, is symbolized by arrows 15. The piston 4 and heater 14 are joined with each other to form a single component in such a way that the heater 14 is arranged on a surface 16 of the piston 4 that faces the first pressure tube chamber 7. The piston 4 is sealed from the inner wall 17 of the pressure tube 3 by a piston ring 18 mounted on the periphery of the piston 4. In a middle section of the maximum travel of the piston 4 of the actuating device 6, the inner wall 17 of the pressure tube 3 has a bypass groove 19, through which the pressure fluid can flow to bypass the piston 4. The bypass groove 19 causes end-of-travel damping of the actuating device 6.

A second flow channel 20, which connects the first pressure tube chamber 7 and the second pressure tube chamber 8, is located in the piston 4. The pressure fluid can flow through the two flow channels 12, 20 in opposite directions; specifically, the pressure fluid can flow through the first flow channel 12 from the second pressure tube chamber 8 to the first pressure tube chamber 7 and through the second flow channel 20 from the first pressure tube chamber 7 to the second pressure tube chamber 8. This flow is brought about by check valves 21, 22, which are arranged in opposite directions, one in each of the two flow channels 12, 20. In this regard, the check valve 22 of the second flow channel 20 is a check valve with temperature-dependent closing force; the closing force of this check valve 22 is higher at low temperatures than at high temperatures. This prevents the piston 4 from making a return stroke when the pressure is decreasing.

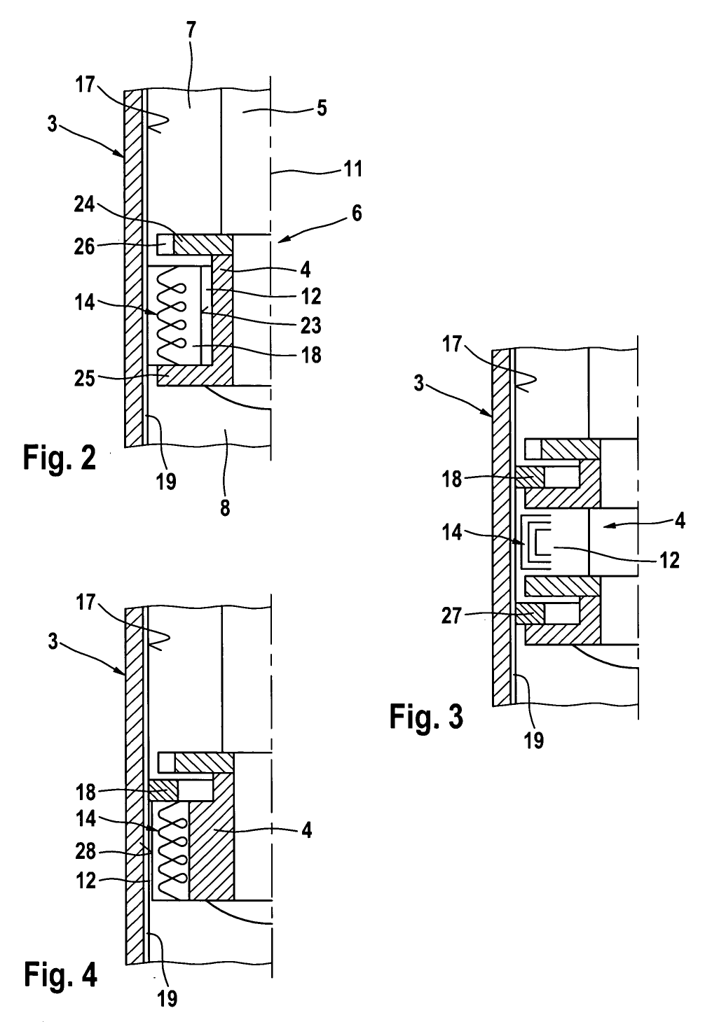

FIG. 2 shows a detail section of a pressure tube of another gas spring filled with a pressure fluid. This gas spring will not be described beyond the additional features it illustrates. Here again, as in the embodiment illustrated in FIG. 1, there is an actuating device 6, which has a piston rod 5 and a piston 4 that separates a first pressure tube chamber 7 from a second pressure tube chamber 8. The piston 4 is sealed from an inner wall 17 of the pressure tube 3 by a piston ring 18, which is mounted radially between the piston 4 and the inner wall 17 of the pressure tube 3. A bypass groove 19 in the inner wall 17 of the pressure tube 3 serves as a bypass line for bypassing the piston 4 to provide end-of-travel damping of the piston 4.

An outer surface of the piston 4 that faces the piston ring 18 and an inner surface of the piston ring 18 that faces the piston 4 form a section of a flow channel 12 that connects the first pressure tube chamber 7 and the second pressure tube chamber 8. In its end regions facing the pressure tube chambers 7, 8, the flow channel 12 continues in labyrinthine fashion between the piston ring 18 and the piston 4 and, finally, between the piston 4 and the inner wall 17 of the pressure tube 3.

A heater 14 for heating pressure fluid flowing through the flow channel 12 is installed in and forms an integral part of the piston ring 18. The heater 14 is installed in the piston ring 18 in such a way that it borders directly on the flow channel 12 and forms a wall 23 of the flow channel 12.

The piston ring 18 can be moved axially relative to the piston 4, i.e., parallel to the direction of the center axis 11 of the pressure tube 3. The piston 4 has a first axial stop 24 and a second axial stop 25, which is spaced a certain axial distance from the first axial stop 24, to limit the axial movement of the piston ring 18. In this way, the piston ring 18 simultaneously acts as a check valve for closing the flow channel 12. In the position shown here, in which the piston ring 18 rests against the second axial stop 25, which faces the second pressure tube chamber 8, the flow channel 12 is closed; pressure fluid cannot flow back from the first pressure tube chamber 7 into the second pressure tube chamber 8. However, pressure fluid can flow over from the second pressure tube chamber 8 to the first pressure tube chamber 7: In this case, the pressure fluid moves the piston ring 18 against the first axial stop 24, which has a passage 26 through which the pressure fluid can flow.

FIG. 3 shows a detail section of a similar embodiment of a gas spring with a pressure tube 3 filled with a pressure fluid. In this case, however, the piston 4 has two axially spaced piston rings 18, 27, and a heater 14 is installed between the two piston rings 18, 27 in a flow channel 12, so that the pressure fluid can flow through the heater 14. A bypass groove 19 is provided in the inner wall 17 of the pressure tube 3 to allow end-of-travel damping of the piston 4.

FIG. 4 shows a detail section of another embodiment of a gas spring with a pressure tube 3 filled with a pressure fluid. In this case, a piston 4 is provided, which forms a flow channel 12 with an inner wall 17 of the pressure tube 3. A heater 14 for heating pressure fluid flowing through the flow channel 12 is installed in and forms an integral part of the piston 4. The heater 14 forms a wall 28 of the flow channel 12, and a piston ring 18 acts as a check valve in the flow channel 12. In this embodiment as well, a bypass groove 19 is provided in the inner wall 17 of the pressure tube 3 to allow end-of-travel damping of the piston 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A gas spring comprising:
a pressure tube having a first pressure chamber and a second pressure chamber, said pressure tube being filled with a pressure fluid;
an actuating device that can move relative to the pressure tube and is acted on by the pressure fluid;
a first flow channel connecting the first pressure chamber to the second pressure chamber; and
a heater arranged within the flow channel and/or immediately adjacent to the flow channel.

2. The gas spring of claim 1 wherein the flow channel has an inlet and an outlet, the heater being installed at one of the inlet and the outlet, the pressure fluid flowing through and/or around the heater.

3. The gas spring of claim 1 wherein the actuating device comprises a piston which separates the first pressure chamber from the second pressure chamber, wherein the piston can be bypassed by pressure fluid through the flow channel.

4. The gas spring of claim 3 wherein the flow channel is in the piston.

5. The gas spring of claim 3 wherein the piston and the heater are integrated to form a single component.

6. The gas spring of claim 3 wherein the pressure tube has an inner wall and the piston has an outer surface, the gas spring further comprising a piston ring fitted radially between the inner wall of the pressure tube and the outer surface of the piston, the piston ring having an inner surface, the inner surface of the piston ring and the outer surface of the piston at least partially defining the flow channel.

7. The gas spring of claim 7 wherein the heater is installed in the piston ring.

8. The gas spring of claim 6 wherein the piston ring is axially movable relative to the piston.

9. The gas spring of claim 8 wherein the piston comprises first and second axial stops which limit movement of the piston ring relative to the piston, the piston being installed between the two axial stops.

10. The gas spring of claim 1 wherein the flow channel comprises a wall defined by part of the heater.

11. The gas spring of claim 6 comprising two axially spaced piston rings, the heater being installed in the flow channel between the two piston rings, the pressure fluid flowing at least one of through and around the heater.

12. The gas spring of claim 1 further comprising a second flow channel connecting the first pressure chamber to the second pressure chamber, wherein the pressure fluid can flow through the first and second channels in respective opposite directions.

13. The gas spring of claim 12 further comprising a check valve in each of the first and second flow channels.

14. The gas spring of claim 13 wherein the check valve in the second flow channel has a closing force which is temperature dependent.

15. The gas spring of claim 1 wherein the actuating device has a maximum travel with respect to the pressure tube, the pressure tube having an inner wall with a bypass groove in a middle section of the maximum travel, wherein the pressure fluid can flow through the bypass groove to bypass the actuating device.
